(19) United States
(12) Patent Application Publication
(10) Pub. No.: US 2026/0084360 A1
(43) Pub. Date: Mar. 26, 2026

(54) VENT STUFFER FOR EXTRUDER AND EXTRUSION APPARATUS

(71) Applicant: THE JAPAN STEEL WORKS, LTD., Shinagawa-ku, Tokyo (JP)

(72) Inventor: Daigo SAGA, Tokyo (JP)

(21) Appl. No.: 19/113,405

(22) PCT Filed: May 26, 2023
(86) PCT No.: PCT/JP2023/019799

§ 371 Date: Mar. 19, 2025

(51) Int. Cl. B29C 48/76

(52) U.S. Cl. CPC B29C 48/766

(57) ABSTRACT

A vent stuffer 20 for extruder according to one embodiment includes a cylinder 21 having a cylinder hole 30a and a screw 23a arranged in the cylinder hole 30a. An inner wall 31 of the cylinder hole 30a has an upper surface portion 31a and a lower surface portion 31b, and the screw 23a is located between the upper surface portion 31a and the lower surface portion 31b. A clearance C1 between the screw 23a and the upper surface portion 31a is larger than a clearance C2 between the screw 23a and the lower surface portion 31b.

### TECHNICAL FIELD

The present invention relates to a vent stuffer for extruder and an extrusion apparatus.

### BACKGROUND ART

Extruders configured to melt, knead, and thermally decompose raw materials or ingredients and then extrude them from a cylinder are known. Patent Document 1 discloses an extruder provided with a vent stuffer. A vent stuffer is a degasser for removing a gas from a cylinder of an extruder. A vent stuffer includes a cylinder connected to a cylinder of an extruder and a screw arranged in the cylinder.

The gas generated in a cylinder of an extruder flows into a cylinder of a vent stuffer, and is recovered via the cylinder of the vent stuffer or discharged to the atmosphere. Also, a part of the raw material or ingredient flowing out of the cylinder of the extruder together with the gas and flowing into the cylinder of the vent stuffer is retained in the cylinder of the vent stuffer or returned to the cylinder of the extruder by a screw of the vent stuffer.

### RELATED ART DOCUMENTS

### Patent Documents

Patent Document 1: Japanese Unexamined Patent Application Publication No. 2022-71945

### SUMMARY OF THE INVENTION

### Problems to be Solved by the Invention

The vent stuffer for extruder and the extruder need to prevent raw materials or ingredients from blowing out of the respective cylinders.

Other problems and novel features will be apparent from the description of this specification and accompanying drawings.

### Means for Solving Problems

According to one embodiment, a vent stuffer for extruder includes a cylinder having a cylinder hole and a screw arranged in the cylinder hole. An inner wall of the cylinder hole has an upper surface portion and a lower surface portion, and the screw is located between the upper surface portion and the lower surface portion. Also, a clearance between the screw and the upper surface portion is larger than a clearance between the screw and the lower surface portion.

### Effects of the Invention

According to one embodiment, it is possible to prevent raw materials or ingredients from blowing out of cylinders of a vent stuffer for extruder and an extruder.

### BRIEF DESCRIPTIONS OF THE DRAWINGS

FIG. 1 is a schematic diagram illustrating a configuration of an extrusion apparatus according to one embodiment.

FIG. 2 is a cross-sectional view of the extrusion apparatus taken along a line A-A in FIG. 1.

FIG. 3 is an enlarged cross-sectional view taken along a line X-X in FIG. 2.

FIG. 4 is an enlarged cross-sectional view taken along a line Y-Y in FIG. 2.

FIG. 5 is an enlarged cross-sectional view taken along a line Z-Z in FIG. 2.

FIG. 6 is a cross-sectional view illustrating a height of an internal space of a cylinder according to one embodiment.

FIG. 7 is a cross-sectional view illustrating a relationship between a maximum diameter of a main screw and a maximum diameter of a screw according to one embodiment.

FIG. 8 is a cross-sectional view illustrating a chamber and its vicinity according to one embodiment.

FIG. 9 is another cross-sectional view illustrating a chamber and its vicinity according to one embodiment.

### DETAILED DESCRIPTION OF PREFERRED EMBODIMENTS

Hereinafter, one embodiment will be described in detail with reference to drawings. Note that the devices and members having the same or substantially same function are denoted by the same reference characters throughout the drawings for describing the embodiment. Further, the repetitive description of the devices and members described once will be omitted in principle.

### <Configuration of Extrusion Apparatus>

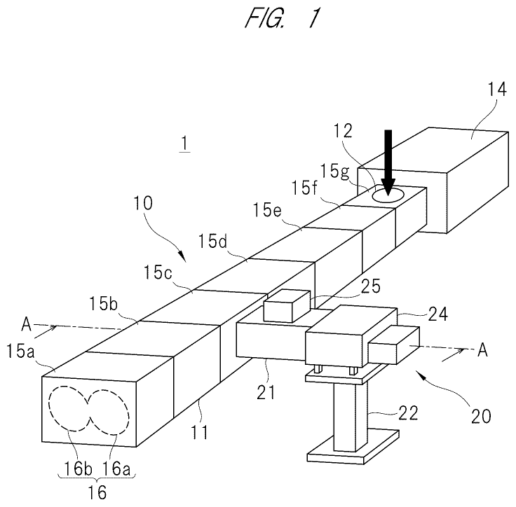

FIG. 1 is a schematic diagram illustrating a configuration of an extrusion apparatus 1 according to the present embodiment. The extrusion apparatus 1 includes an extruder main body 10 and a vent stuffer 20 for extruder. In the following description, the vent stuffer 20 for extruder may be abbreviated as a “vent stuffer 20”.

The extrusion apparatus 1 according to the present embodiment can process waste plastics through the following process. More specifically, the extrusion apparatus 1 according to the present embodiment can recycle waste plastics through the following process.

First, crushed waste plastics are supplied to the extruder main body 10. More specifically, the waste plastics are supplied into a cylinder 11 through a raw material supply port 12 provided at or near a rear end of the cylinder 11. Although the illustration thereof is omitted, a hopper to which the waste plastics are fed is connected to the raw material supply port 12.

The waste plastics supplied to the extruder main body 10 are, for example, plastic pieces discarded as household garbage or industrial waste and crushed by a crusher. In the following description, the waste plastics supplied to the extruder main body 10 may be referred to as a “raw material”.

The raw material supplied to the extruder main body 10 is conveyed toward a tip end of the cylinder 11 while being kneaded. More specifically, the raw material supplied into the cylinder 11 is melted and kneaded while being sent forward by the rotation of a screw provided in the cylinder 11.

The raw material (kneaded material/molten resin) kneaded by the extruder main body 10 is extruded to the outside through a die head attached to the tip end of the cylinder 11. The kneaded material is formed into a strand shape (string-like shape, rope-like shape) by passing through a nozzle of the die head.

The strand-shaped kneaded material extruded from the die head is cut by a cutting apparatus (pelletizer). From another perspective, the strand-shaped kneaded material extruded from the die head is divided into pellets. As a result, resin pellets of the desired size (length and thickness) are obtained.

In the above process, gas may be generated in the cylinder 11 of the extruder main body 10. For example, volatile gas may be generated as the raw material is kneaded and melted. In particular, waste plastics often contain moisture, and a large amount of gas may be generated.

The vent stuffer 20 includes a cylinder 21 connected to the cylinder 11 of the extruder main body 10, and removes the gas from the cylinder 11 of the extruder main body 10. In the following description, the cylinder 11 of the extruder main body 10 may be referred to as a “main cylinder 11” to distinguish it from the cylinder 21 of the vent stuffer 20.

The main cylinder 11 of the extruder main body 10 and the cylinder 21 of the vent stuffer 20 mutually communicate with each other. For this reason, the gas generated in the main cylinder 11 may flow into the cylinder 21 of the vent stuffer 20, and a part of the kneaded material or particles (hereinafter, may be collectively referred to as an “ejected material”) may flow into the cylinder 21 of the vent stuffer 20 together with the gas.

Therefore, a screw is provided in the cylinder 21 of the vent stuffer 20. The ejected material that has flowed into the cylinder 21 from the main cylinder 11 is retained in the cylinder 21 or returned to the main cylinder 11 by the rotation of the screw provided in the cylinder 21. In the following description, the screw provided in the extruder main body 10 may be referred to as a “main screw” to distinguish it from the screw provided in the vent stuffer 20.

Note that, although the description thereof is omitted, the extruder main body 10 is placed on a bed. On the other hand, the vent stuffer 20 is placed on a support stand 22 so as to match its height with the extruder main body 10. Understandably, in another embodiment, the vent stuffer 20 may be provided with a support unit or support legs in place of the support stand 22.

### <Extruder Main Body>

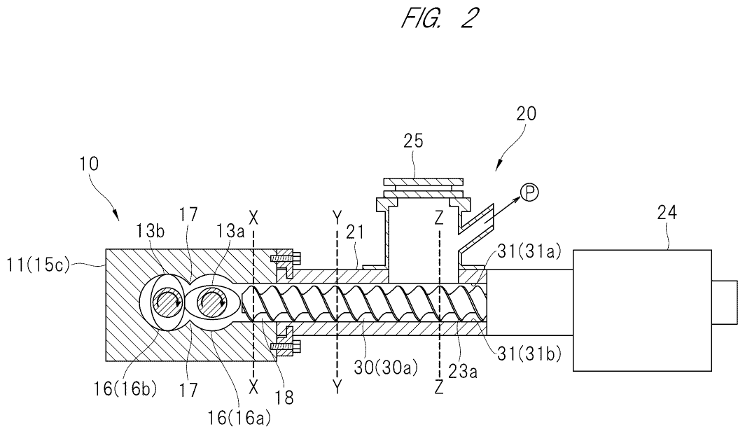

Next, the extruder main body 10 will be described in more detail. FIG. 2 is a cross-sectional view of the extrusion apparatus 1 taken along a line A-A in FIG. 1. Note that the support stand 22 illustrated in FIG. 1 is omitted in FIG. 2.

As illustrated in FIG. 1 and FIG. 2, the extruder main body 10 includes the main cylinder 11, the raw material supply port 12, main screws 13a and 13b, and a drive unit 14. From another perspective, the extruder main body 10 is a twin-screw extruder provided with two screws arranged in parallel.

The main cylinder 11 is made up of a plurality of blocks arranged in a line. More specifically, the main cylinder 11 is made up of seven blocks 15a, 15b, 15c, 15d, 15e, 15f, and 15g arranged in a line.

Each of the blocks 15a, 15b, 15c, 15d, 15e, 15f, and 15g is provided with a through hole. The through holes formed in the blocks 15a to 15g communicate with each other, so that a cylinder hole 16 is formed in the main cylinder 11.

The cylinder hole 16 includes a cylinder hole 16a in which the main screw 13a is arranged and a cylinder hole 16b in which the main screw 13b is arranged. The cylinder hole 16a and the cylinder hole 16b are arranged in parallel and communicate with each other.

Two protrusions 17 facing each other are provided between the cylinder hole 16a and the cylinder hole 16b. One protrusion 17 protrudes downward, and the other protrusion 17 protrudes upward. In other words, the main cylinder 11 has a spectacle-like shape. From another perspective, a ceiling surface and a bottom surface of the cylinder hole 16 are not flat.

The drive unit 14 includes a motor and a decelerator. The main screws 13a and 13b are driven to rotate by the driving force output from the motor and input via the decelerator.

The raw material fed to the hopper falls into the cylinder hole 16 through the raw material supply port 12. The raw material that has fallen into the cylinder hole 16 is conveyed forward while being kneaded by the main screws 13a and 13b rotating in the cylinder hole 16. At the same time, the raw material is melted by the heat generated by a heater provided in the main cylinder 11 and the heat generated by the shear heating.

Note that the raw material supply port 12 is provided in an upper surface of the rearmost block 15g, and the drive unit 14 is arranged at the further back of the block 15g.

### <Outline of Vent Stuffer>

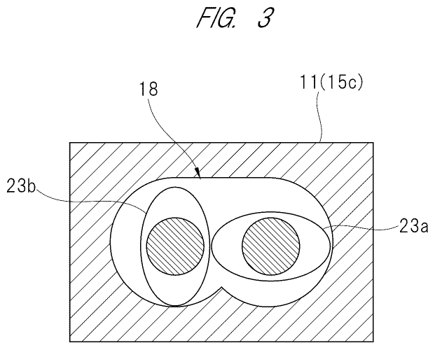

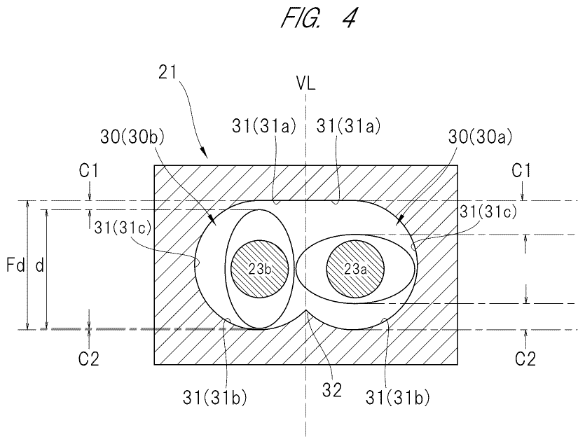

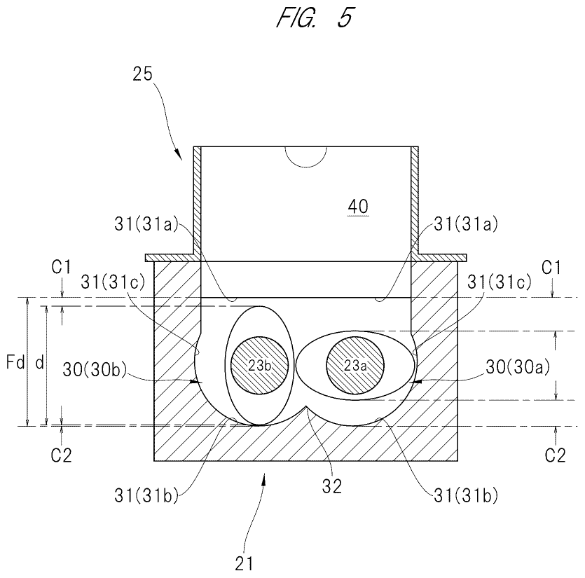

FIG. 3 is an enlarged cross-sectional view taken along a line X-X in FIG. 2. FIG. 4 is an enlarged cross-sectional view taken along a line Y-Y in FIG. 2. FIG. 5 is an enlarged cross-sectional view taken along a line Z-Z in FIG. 2.

The vent stuffer 20 includes the cylinder 21, screws 23a and 23b, a drive unit 24, and a chamber 25. From another perspective, the vent stuffer 20 is a twin-screw degassing apparatus provided with two screws arranged in parallel.

### <Cylinder>

The cylinder 21 of the vent stuffer 20 is connected to one of the plurality of blocks constituting the main cylinder 11 of the extruder main body 10. More specifically, the cylinder 21 is connected to a side surface of the block 15c. From another perspective, the cylinder 21 of the vent stuffer 20 is perpendicular to the main cylinder 11 of the extruder main body 10.

In another embodiment, the cylinder 21 of the vent stuffer 20 may be connected to an upper surface of the block 15c or another block.

### <Cylinder Hole>

The cylinder 21 of the vent stuffer 20 has a cylinder hole 30 communicating with the cylinder hole 16 of the main cylinder 11. As mainly illustrated in FIG. 4, the cylinder hole 30 includes a cylinder hole 30a in which the screw 23a is arranged and a cylinder hole 30b in which the screw 23b is arranged.

The cylinder hole 30a and the cylinder hole 30b are arranged in parallel and communicate with each other. Also, the cylinder hole 30a and the cylinder hole 30b have the same cross-sectional shape and cross-sectional area. More specifically, the cylinder hole 30a and the cylinder hole 30b have cross-sectional shapes that are line-symmetric with respect to a virtual line VL illustrated in FIG. 4 as the axis of symmetry.

Each of the cylinder holes 30a and 30b has an inner wall 31 including an upper surface portion 31a, a lower surface portion 31b, and a side surface portion 31c. The screw 23a is located between the upper surface portion 31a and the lower surface portion 31b of the inner wall 31 of the cylinder hole 30a. The screw 23b is located between the upper surface portion 31a and the lower surface portion 31b of the inner wall 31 of the cylinder hole 30b.

From another perspective, the upper surface portion 31a and the lower surface portion 31b of the inner wall 31 of the cylinder hole 30a face each other with the screw 23a interposed therebetween. Similarly, the upper surface portion 31a and the lower surface portion 31b of the inner wall 31 of the cylinder hole 30b face each other with the screw 23b interposed therebetween.

The side surface portion 31c of the cylinder hole 30a connects one side of the upper surface portion 31a and one side of the lower surface portion 31b of the cylinder hole 30a. Similarly, the side surface portion 31c of the cylinder hole 30b connects one side of the upper surface portion 31a and one side of the lower surface portion 31b of the cylinder hole 30b. As a result, the side surface portion 31c of the cylinder hole 30a and the side surface portion 31c of the cylinder hole 30b face each other with the screw 23a and the screw 23b interposed therebetween.

From another perspective, the upper surface portion 31a of the cylinder hole 30a forms a ceiling surface of the cylinder hole 30a, the lower surface portion 31b thereof forms a bottom surface of the cylinder hole 30a, and the side surface portion 31c thereof forms an inner side surface of the cylinder hole 30a. Similarly, the upper surface portion 31a of the cylinder hole 30b forms a ceiling surface of the cylinder hole 30b, the lower surface portion 31b thereof forms a bottom surface of the cylinder hole 30b, and the side surface portion 31c thereof forms an inner side surface of the cylinder hole 30b.

The upper surface portions 31a of the cylinder holes 30a and 30b are flat. Also, the upper surface portion 31a of the cylinder hole 30a and the upper surface portion 31a of the cylinder hole 30b form a series of flat surface continuing without a boundary. From another perspective, the upper surface portion 31a of the cylinder hole 30a and the upper surface portion 31a of the cylinder hole 30b are flush with each other and form a flat ceiling surface of the cylinder hole 30.

The lower surface portions 31b of the cylinder holes 30a and 30b are curved surfaces. More specifically, the lower surface portion 31b of the cylinder hole 30a is a curved surface along the screw 23a, and the lower surface portion 31b of the cylinder hole 30b is a curved surface along the screw 23b.

A convex protrusion 32 protruding upward is provided between the lower surface portion 31b of the cylinder hole 30a and the lower surface portion 31b of the cylinder hole 30b. From another perspective, the pointed protrusion 32 protruding toward the ceiling surface is provided on the bottom surface of the cylinder hole 30. Namely, the ceiling surface of the cylinder hole 30 is flat, and the bottom surface of the cylinder hole 30 is not flat. Note that the virtual line VL illustrated in FIG. 4 is also a vertical line passing through the apex of the protrusion 32.

### <Connection Hole>

As illustrated in FIG. 2, a connection hole 18 through which the main cylinder 11 of the extruder main body 10 and the cylinder 21 of the vent stuffer 20 communicate is provided in the main cylinder 11. The connection hole 18 is provided in the block 15c to which the cylinder 21 is connected. The connection hole 18 penetrates through the side wall of the block 15c and is connected to the cylinder hole 16 and the cylinder hole 30.

As illustrated in FIG. 3 and FIG. 4, the connection hole 18 and the cylinder hole 30 have the same cross-sectional shape and cross-sectional area. Also, tip portions of the screws 23a and 23b protruding from the cylinder 21 of the vent stuffer 20 are inserted into the connection hole 18. More specifically, the tip portion of the screw 23a protruding from the cylinder hole 30a is inserted into one side of the connection hole 18 leading to the cylinder hole 30a, and the tip portion of the screw 23b protruding from the cylinder hole 30b is inserted into the other side of the connection hole 18 leading to the cylinder hole 30b.

From another perspective, the screws 23a and 23b of the vent stuffer 20 span over the cylinder 21 and the main cylinder 11 (see FIG. 2).

### <Clearance>

As illustrated in FIG. 4, a clearance C1 between the screw 23a and the upper surface portion 31a of the cylinder hole 30a is larger than a clearance C2 between the screw 23a and the lower surface portion 31b of the cylinder hole 30a. Similarly, a clearance C1 between the screw 23b and the upper surface portion 31a of the cylinder hole 30b is larger than a clearance C2 between the screw 23b and the lower surface portion 31b of the cylinder hole 30b. From another perspective, the clearance C1 between the screws 23a and 23b and the ceiling surface of the cylinder hole 30 is larger than the clearance C2 between the screws 23a and 23b and the bottom surface of the cylinder hole 30.

The above-described relationship in size between the clearance C1 and the clearance C2 (C1>C2) is always maintained regardless of the rotation angles of the screws 23a and 23b. Also, the above-described relationship in size (C1>C2) is maintained throughout the length of the cylinder 21. Further, the same or substantially same relationship in size is established also in the connection hole 18 having the same cross-sectional shape and cross-sectional area as those of the cylinder hole 30.

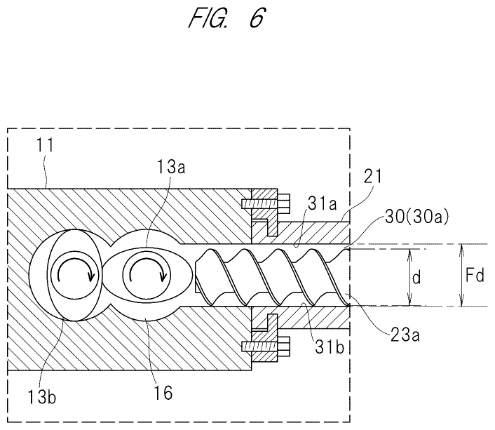

FIG. 6 is a cross-sectional view illustrating a height of an internal space of the cylinder 21. In the present embodiment, the above-described relationship in size between the clearance C1 and the clearance C2 (C1>C2) is realized by flattening the ceiling surface of the cylinder hole 30. From another perspective, the height of the internal space of the cylinder 21 is increased by flattening the ceiling surface of the cylinder hole 30.

More specifically, a facing distance Fd between the upper surface portion 31a and the lower surface portion 31b of the cylinder hole 30a illustrated in FIG. 6 is set to 1.1 times or more the maximum diameter (thread diameter/major diameter) d of the screw 23a. From another perspective, the ratio (Fd/d) of the facing distance Fd to the maximum diameter d is set to 1.1 or more.

Further, a facing distance Fd between the upper surface portion 31a and the lower surface portion 31b of the cylinder hole 30b not illustrated in FIG. 6 is also set to 1.1 times or more the maximum diameter (thread diameter) d of the screw 23b.

As already described, the ceiling surface of the cylinder hole 30 is formed by the upper surface portions 31a of the cylinder holes 30a and 30b, and the bottom surface of the cylinder hole 30 is formed by the lower surface portions 31b of the cylinder holes 30a and 30b. Therefore, the facing distance Fd between the upper surface portion 31a and the lower surface portion 31b corresponds to the height of the internal space of the cylinder 21.

In the present embodiment, the height of the internal space of the cylinder 21 is set to a height that satisfies the condition (Fd/d≥1.1), and the centers of the screws 23a and 23b are offset downward with respect to the center of the cylinder hole 30.

From another perspective, in the present embodiment, spaces wider than those below the screws 23a and 23b are secured above the screws 23a and 23b in the cylinder hole 30. Therefore, the flow velocity of the gas flowing into the cylinder hole 30 from the cylinder hole 16 through the connection hole 18 is reduced or at least the increase of the flow velocity is suppressed. As a result, it is possible to prevent or suppress the ejected material flowing from the main cylinder 11 into the cylinder 21 from blowing out of the cylinder 21.

Also, the ejected material flowing into the cylinder 21 together with the gas flow is retained in the cylinder 21 or returned to the main cylinder 11 by the rotating screws 23a and 23b.

Here, from the viewpoint of reducing the velocity of the gas flow, it is preferable that the spaces around the screws 23a and 23b (gaps between the cylinder hole 30 and the screws 23a and 23b) are further increased. More specifically, it is preferable to further increase the above ratio (Fd/d). However, according to the studies by the inventor, the flow velocity of the gas flow becomes almost constant when the above ratio (Fd/d) exceeds 2.0. Also, if the facing distance Fd is increased in order to increase the above ratio (Fd/d), the strength and durability of the cylinder 21 may be lowered and the cylinder 21 may be enlarged in size. From these perspectives, the ratio (Fd/d) is preferably 1.1 or larger and 2.0 or smaller, and more preferably 1.5 or larger and 2.0 or smaller.

Also, even when the clearance C1 and the clearance C2 are the same, the velocity of the gas flow is reduced when the spaces around the screws 23a and 23b are increased. However, if the spaces around the screws 23a and 23b are too large, the conveying ability of the screws 23a and 23b may be lowered. Namely, there is the possibility that the ability of retaining the ejected material in the cylinder 21 or returning it to the main cylinder 11 may be lowered.

From the viewpoint of maintaining and improving the conveying ability of the screws 23a and 23b, it is preferable that the clearance C2 is as small (narrow) as possible. Namely, it is preferable that the desired ratio (Fd/d) is achieved by minimizing the clearance C2 and maximizing the clearance C1.

In the present embodiment, flattening the ceiling surface of the cylinder hole 30 contributes to the achievement of the desired ratio (Fd/d) by the minimization of the clearance C2 and the maximization of the clearance C1. However, flattening the bottom surface of the cylinder hole 30 is not excluded.

On the other hand, the flow of the gas flowing into the cylinder hole 30, in particular, the flow of the volatile gas passes through an upper part of the cylinder hole 30. Meanwhile, most of the ejected material flowing into the cylinder hole 30 falls to a lower part of the cylinder hole 30 due to its own weight. Therefore, from the viewpoint of achieving both the maintenance of the conveying ability of the screws 23a and 23b and the reduction of velocity of gas flow, it is preferable to achieve the desired ratio (Fd/d) by the minimization of the clearance C2 and the maximization of the clearance C1, and for this purpose, it is effective to make the ceiling surface of the cylinder hole 30 to be a flat surface and the bottom surface thereof to be a curved surface.

### <Clearance Securement by Screw Diameter>

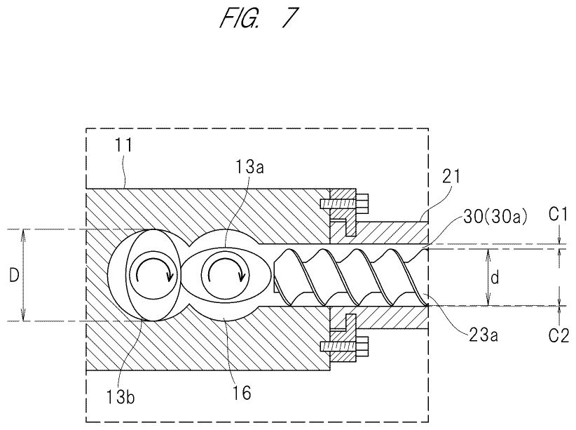

The above-described relationship in size between the clearance C1 and the clearance C2 (C1>C2) can also be achieved by reducing the diameter of the screws 23a and 23b. FIG. 7 is a cross-sectional view illustrating a relationship between the maximum diameter D of the main screws 13a and 13b of the extruder main body 10 and the maximum diameter d of the screws 23a and 23b of the vent stuffer.

It is obvious that the clearance C1 will increase if the maximum diameter d of the screw 23a illustrated in FIG. 7 is reduced. From another perspective, a larger space will be created above the screw 23a in the cylinder hole 30 if the maximum diameter d of the screw 23a is reduced.

However, if the maximum diameter d of the screw 23a is too small, the conveying ability 23a will be insufficient. Therefore, when trying to achieve the above-described relationship in size (C1>C2) by reducing the diameter of the screw 23a, the maximum diameter d of the screws 23a and 23b is preferably 0.2 to 0.8 times the maximum diameter D of the main screws 13a and 13b, and more preferably 0.4 to 0.8 times.

### <Chamber>

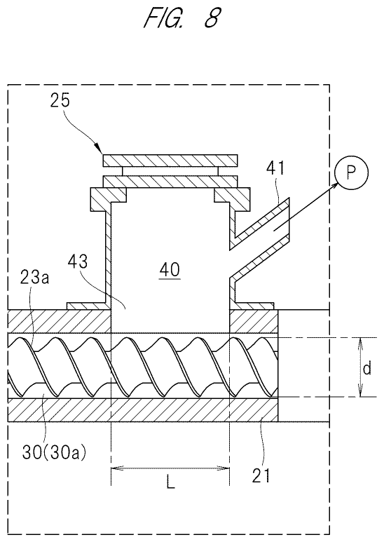

FIG. 8 is a cross-sectional view illustrating the chamber 25 and its vicinity. The chamber 25 includes a cylindrical buffer room 40 and an exhaust pipe 41 extending from the buffer room 40. An opening 43 communicating with the cylinder hole 30 is provided at the bottom of the buffer room 40, and the exhaust pipe 41 is connected to a vacuum pump P.

The gas generated in the main cylinder 11 passes through the cylinder 21 (cylinder hole 30) to reach below the opening 43, and flows into the buffer room 40 from the opening 43. The gas is then sucked out of the buffer room 40 through the exhaust pipe 41.

Here, in order to prevent the ejected material that has reached below the opening 43 together with the gas from flowing out of the buffer room 40, it is effective to enlarge the area of the opening 43. From another perspective, in order to prevent the ejected material from flowing into the exhaust pipe 41 via the buffer room 40, it is effective to enlarge the area of the opening 43.

The gas and the ejected material flow from the tip end side to the rear end side in the cylinder hole 30 along the axial direction of the screws 23a and 23b to reach the opening 43. Therefore, in order to prevent the ejected material from flowing out, it is effective to enlarge the area of the opening 43 by increasing the length L illustrated in FIG. 8. The length L illustrated in FIG. 8 is the length of the opening 43 from one side (tip end side) to the other side (rear end side) along the axial direction of the screws 23a and 23b.

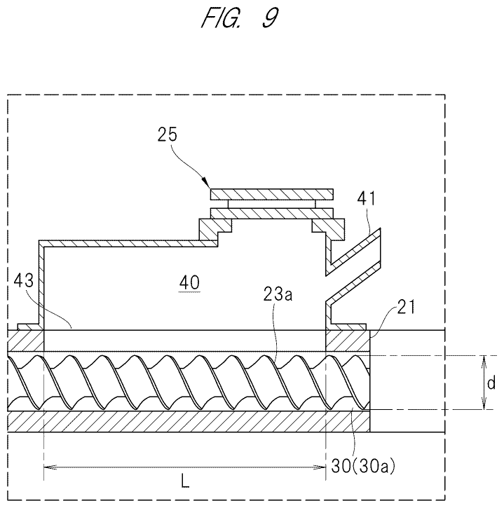

FIG. 9 is a cross-sectional view illustrating the chamber 25 with the opening 43 whose area has been enlarged and its vicinity. As illustrated in FIG. 9, by increasing the length L of the opening 43, the probability that the ejected material that has reached the opening 43 falls into the cylinder hole 30 due to its own weight without flowing into the buffer room 40 is increased. In addition, the probability that the ejected material that has once flowed into the buffer room 40 falls into the cylinder hole 30 due to its own weight is also increased. Overall, the probability that the ejected material is sucked out of the buffer room 40 together with the gas is reduced.

From the viewpoint of increasing the effect of recovering the ejected material by free falling as described above, it is preferable to set the length L to 2.0 times or more the maximum diameter d of the screws 23a and 23b, and more preferably 3.0 times or more.

Note that, when the ejected material is small (light), it is preferable to increase the length L to increase the possibility of free falling of the ejected material. On the other hand, when the ejected material is large (heavy), it is preferable to reduce the length L to increase the conveying ability of the screws 23a and 23b.

In the foregoing, the invention made by the inventor has been specifically described based on the embodiment and example, but it goes without saying that the present invention is not limited to the above embodiment and example and can be modified in various ways within the range not departing from the gist of the invention.

For example, the use of the extrusion apparatus is not limited to the processing of waste plastics. The extrusion apparatus can be used for melting, kneading, degassing, and others of various raw materials and ingredients.

The form of the raw materials and ingredients processed by the extrusion apparatus is not particularly limited. The extrusion apparatus can process raw materials and ingredients in various forms such as pellets, granules, powder, and others.

The screws provided in the extruder main body and the vent stuffer for extruder may be of the intermeshing type or the non-intermeshing type. Understandably, the extruder main body and the vent stuffer for extruder are not limited to the twin-screw type.

REFERENCE SIGNS LIST

1 . . . extrusion apparatus, 10 . . . extruder main body, 11 . . .
cylinder (main cylinder), 12 . . . raw material supply port, 13a, 13b . . .
screw (main screw), 14 . . . drive unit, 15a-15g . . . block, 16, 16a,
16b . . . cylinder hole, 17 . . . protrusion, 18 . . . connection hole,
20 . . . vent stuffer for extruder (vent stuffer), 21 . . . cylinder, 22 . . .
support stand, 23a, 23b . . . screw, 24 . . . drive unit, 25 . . . chamber, 30,
30a, 30b . . . cylinder hole, 31 . . . inner wall, 31a . . . upper surface
portion, 31b . . . lower surface portion, 31c, side surface portion, 32 . . .
protrusion, 40 . . . buffer room, 41 . . . exhaust pipe, 43 . . . opening, C1,
C2 . . . clearance, d . . . maximum diameter (thread diameter), D . . .
maximum diameter, Fd . . . facing distance, P . . . vacuum pump, VL . . .
virtual line

1. A vent stuffer for extruder comprising:
a cylinder connected to an extruder main body and having a cylinder hole; and
a screw arranged in the cylinder hole,
wherein an inner wall of the cylinder hole has an upper surface portion and a lower surface portion,
wherein the screw is located between the upper surface portion and the lower surface portion, and
wherein a clearance between the screw and the upper surface portion is larger than a clearance between the screw and the lower surface portion.

2. The vent stuffer for extruder according to claim 1,
wherein the upper surface portion is a flat surface, and
wherein the lower surface portion is a curved surface along the screw.

3. The vent stuffer for extruder according to claim 1,
wherein a facing distance between the upper surface portion and the lower surface portion is 1.1 times or more a maximum diameter of the screw.

4. The vent stuffer for extruder according to claim 1,
wherein a maximum diameter of the screw is 0.8 times or less a maximum diameter of a screw provided in the extruder main body.

5. The vent stuffer for extruder according to claim 1, further comprising a chamber arranged above the cylinder and having an opening communicating with the cylinder hole,
wherein a length of the opening from one side to an other side along an axial direction of the screw is 2.0 times or more a maximum diameter of the screw.

6. The vent stuffer for extruder according to claim 1,
wherein the screw includes a first screw and a second screw,
wherein the cylinder hole includes a first cylinder hole in which the first screw is arranged and a second cylinder hole in which the second screw is arranged,
wherein the upper surface portion of the first cylinder hole and the upper surface portion of the second cylinder hole are a series of flat surface,
wherein the lower surface portion of the first cylinder hole is a curved surface along the first screw, and
wherein the lower surface portion of the second cylinder hole is a curved surface along the second screw.

7. An extrusion apparatus comprising:
an extruder main body; and
a vent stuffer for extruder connected to the extruder main body,
wherein the extruder main body includes: a main cylinder having a cylinder hole; and a main screw arranged in the cylinder hole,
wherein the vent stuffer for extruder includes: a cylinder connected to the main cylinder and having a cylinder hole; and a screw arranged in the cylinder hole,
wherein an inner wall of the cylinder hole of the vent stuffer for extruder has an upper surface portion and a lower surface portion,
wherein the screw of the vent stuffer for extruder is located between the upper surface portion and the lower surface portion, and
wherein a clearance between the screw and the upper surface portion is larger than a clearance between the screw and the lower surface portion.

8. The extrusion apparatus according to claim 7,
wherein a maximum diameter of the screw of the vent stuffer for extruder is 0.8 times or less a maximum diameter of the main screw of the extruder main body.

9. The extrusion apparatus according to claim 7,
wherein a connection hole through which the main cylinder of the extruder main body and the cylinder of the vent stuffer for extruder communicate is provided in the main cylinder,
wherein the connection hole has a same cross-sectional shape and cross-sectional area as those of the cylinder hole of the vent stuffer for extruder, and
wherein a tip portion of the screw of the vent stuffer for extruder, which protrudes from the cylinder of the vent stuffer for extruder, is inserted into the connection hole.
